(19) United States
(12) Patent Application Publication
(10) Pub. No.: US 2020/0256802 A1
(43) Pub. Date: Aug. 13, 2020

(54) HAND-HELD QUANTITATIVE DETECTION DEVICE

(71) Applicant: Shenzhen Zai Tian Yi Fang Technology Co., Ltd, Shenzhen (CN)

(72) Inventors: Song Chen, Shenzhen (CN); Rui Zeng, Shenzhen (CN)

(21) Appl. No.: 16/575,382

(22) Filed: Sep. 18, 2019

(30) Foreign Application Priority Data
Jul. 19, 2018 (CN) 201821160328.X

(51) Int. Cl. G01N 21/78

(52) U.S. Cl. CPC G01N 21/78; G01N 2201/0221

(57) ABSTRACT

The present disclosure relates to a hand-held quantitative detection device, including a housing, an optical structure, a motion structure, a main control circuit board, a power source module, a display device, and a key assembly. One end of the housing in correspondence with the motion structure is provided with a first through hole for insertion of a reagent card. A bottom side of the display device is soldered to a middle of the front side of the main control circuit board. The optical structure is mounted on one end of the front side of the main control circuit board. The motion structure is mounted on one end of the back side of the main control circuit board. The power source module is mounted in a middle portion of the back side of the main control circuit board.

### CROSS REFERENCE TO RELATED APPLICATIONS

The present application claims the benefit of Chinese Patent Application No. 201821160328.X filed on Jul. 19, 2018, the contents of which are incorporated herein by reference in their entirety.

### TECHNICAL FIELD

The present disclosure relates to a detection device, and in particular to a hand-held quantitative detection device.

### BACKGROUND TECHNOLOGY

Various chemical substances often experience discoloration after chemical reactions (including complexation reaction, chelation reaction, reduction oxidation reaction, etc.). It can be said that a colour reaction has occurred. The essence of colour reaction is that the chemical reagent molecule entity or the degree of entity aggregation changes before and after the reaction (change in molecular particle diameter or space between molecules), so that it loses or acquires absorption or scattering ability for visible light within specific wavelengths. This is a change of colour in the eyes of a person.

The colour-changing reaction ability of chemical reagents is often used for characterization or labelling of specific chemical substances. Depending on the degree of discoloration and the accuracy of formulation, the change in colour before and after reagent reaction can qualitatively determine the presence of a specific chemical (e.g. human chorionic gonadotropin (HCG) assay for pregnancy, pH indicator for determining pH, etc.), semi-quantitatively estimate the content of specific chemicals (e.g. follicle stimulating hormone (FSH) assay for ovulation cycle estimation, pH test paper for pH value determination, etc.), and even quantitatively determine specific chemical content. In a colour-changing reaction, one type of reaction is to label a target compound by the principle of “chelatometric colouring”. It generally labels an analyte by “colouring” through immune reaction, and determines the content of the analyte according to the degree of concentration of the residual colour after the colouring agent is removed. Due to the convenience and speed of observation of results, the determination of chemicals based on the colour-changing reaction within a visible range has been more widely used in practical life.

FIG. 1 shows an example of a quantitative detection process realized by a double-sandwich immunochromatographic reaction. Chromatographic effect of a selected substrate is used. After a certain concentration of a liquid to be tested is dripped on the substrate, the solution is subjected to chromatography. It moves forward, dissolves the colouring substance on the conjugate pad, and carries the colouring substance with it. When the liquid moves further to a test zone, the target compound that has been mixed with the colouring substance will be “captured” by certain compound solidified on a “test line” (double-sandwich method when the target compound is macromolecular). When liquid continues to carry the residue forwards to a “control line”, the colouring substance that is residual and is not mixed with the target compound will be “captured” by substance similar to the target compound solidified on the “control line” (double-sandwich method). The final colour concentration on the “test line”, or the ratio of the colour concentration on the “test line” and “control line” (or light absorbance of visible light within specific wavebands), and the concentration of the target compound in the liquid to be tested form a corresponding relationship.

It is necessary to observe the light absorbance on two sensitive zones on the “double-line” reagent card in order to obtain the desired concentration of the target compound. To accurately measure the required light-absorbing condition, there are many matured measurement methods and means. The current general method is to use a stepper motor or a speed reduction motor to drive the relative motion between the “specific wavelength light source—induction module” and the reagent card, and drive the stepper motor in open loop mode to pause after each equally-running specified step (or speed reduction motor running at uniform speed at the same time), so that analog to digital conversion module can output sampling in response to photoelectric device. Eventually, a relationship chart for “light absorbance—moving steps” (or “light absorbance—moving time”) is obtained. In the chart shown in FIG. 2, “light absorbance” local maximum value or the area of the “bulge” enclosed by the “light absorbance” curve obtained by corresponding algorithms can be used as reference values for the light absorbance on the “measure line” and the light absorbance on the “control line” mentioned above.

In addition to “colour-changing reaction”, there is also a method of detecting an analyte by utilizing changes in electrochemical characteristics. Simply speaking, when a certain analyte reacts with a reagent capable of conducting electricity, it changes the conductive property of the reagent, i.e. change of resistance, capacitance or inductance of the reagent before and after the detection reaction, change of current signal after passing through the test, and change in the mapping relationship with the solubility of the analyte. The concentration of the analyte can be derived by the change of resistance, capacitance, inductance, or the characteristic changes of the current signal. However, this method requires knowledge of the contents of the liquid to be tested and its details in order to ensure that the change in the conductive property of the reagent is specific to the analyte, and eliminate interference from other ingredients.

The existing detecting device has the following defects. The existing device is complicated to operate and is not suitable for use at home. The existing miniaturized device has no special design in anti-shake and anti-vibration to keep an operating device steady. Liquid sampling is complicated to carry out and is easy to cause contamination to the detection device.

Therefore, the existing technology has drawbacks and needs improvement.

### SUMMARY

The purpose of the present disclosure is to overcome the deficiencies of the prior art and to provide a hand-held quantitative detection device.

The technical solution of the present disclosure is as follows: the present disclosure provides a hand-held quantitative detection device, including a housing, an optical structure mounted in the housing, a motion structure, a main control circuit board, a power source module, a display device and a key assembly mounted on the housing, wherein the main control circuit board is electrically connected to the optical structure, the motion structure, the power source module, the key assembly, and the display device, respectively, one end of the housing in correspondence with the motion structure is provided with a first through hole for insertion of a reagent card, the main control circuit board has a front side and a back side, a bottom side of the display device is soldered to a middle of the front side of the main control circuit board, the optical structure is mounted on one end of the front side of the main control circuit board, the motion structure is mounted on one end of the back side of the main control circuit board, and the power source module is mounted in a middle portion of the back side of the main control circuit board.

In one embodiment, the housing may be provided with a second through hole in correspondence with the key assembly, and the key assembly is accommodated in the second through hole.

In one embodiment, the key assembly may include an arc-shaped key and a small key that coordinate with each other, and a recessed portion is formed on the arc-shaped key and the small key is engaged in the recessed portion.

In one embodiment, the main control circuit board may include a main control circuit, a power source management circuit respectively connected to the main control circuit, a motor drive and control circuit, a signal acquisition and drive circuit, a communication circuit, and a display drive circuit, wherein the key assembly is electrically connected to the signal acquisition and drive circuit and the display drive circuit, respectively, the power source management circuit is electrically connected to the power source module, and the display drive circuit is electrically connected to the display device.

In one embodiment, the optical structure may include a photoelectric conversion tube connected to the signal acquisition and drive circuit, and a light-receiving and noise-reducing structure disposed in a position in correspondence with the photoelectric conversion tube.

In one embodiment, the motion structure may include a frame, a motor mounted on the frame, a screw rod connected to an output end of the motor, a bearing slider mounted on the screw rod, a tray mounted on the bearing slider, and a position-limiting sensor mounted on the housing, wherein the position-limiting sensor is electrically connected to the motor drive and control circuit, the position-limiting sensor is disposed in a position in correspondence with the tray, and the motor is electrically connected to the motor drive and control circuit.

In one embodiment, the motion structure may further include two lateral bearing guide rails provided on two sides of the screw rod, and the bearing slider is slidable on the two lateral bearing guide rails.

In one embodiment, the hand-held quantitative detection device may further include a wireless communication antenna disposed within the housing, the wireless communication antenna being connected to the communication circuit.

In one embodiment, another end of the housing is provided with a third through hole, and a peripheral device interface is mounted in the third through hole and is connected to the power source management circuit.

According to the above solution, the present disclosure provides a hand-held quantitative detection device. The optical structure, the motion structure, the power source module, and the display device are integrated on the main control circuit board, and the degree of integration is high. This facilitates the realization of miniaturization of the device and high space utilization. It is suitable for an adult to hold and operate. It adopts an arc-shaped key and a small key to form a key assembly, which is very suitable for one-hand operation. During use, a user can carry the device all the way, or the device can be placed horizontally on a flat table to complete the test. Slight shaking, external vibration or inclined placement of the device does not affect the test result.

### BRIEF DESCRIPTION OF THE DRAWINGS

FIG. 1 is a schematic view of chromatography of the prior art.

FIG. 2 is a relationship chart of light absorbance and motion distance.

FIG. 3 is a schematic view of the handheld quantitative detection device of the present disclosure.

FIG. 4 is a first schematic view of the mounting of a main control circuit board of the present disclosure.

FIG. 5 is a second schematic view of the mounting of the main control circuit board of the present disclosure.

FIG. 6 is a third schematic view of the mounting of the main control circuit board of the present disclosure (with the display device removed).

FIG. 7 is a schematic view of the motion structure of the present disclosure.

FIG. 8 is a schematic view showing the motion structure of the present disclosure in an operating condition.

FIG. 9 is a circuit diagram of the present disclosure.

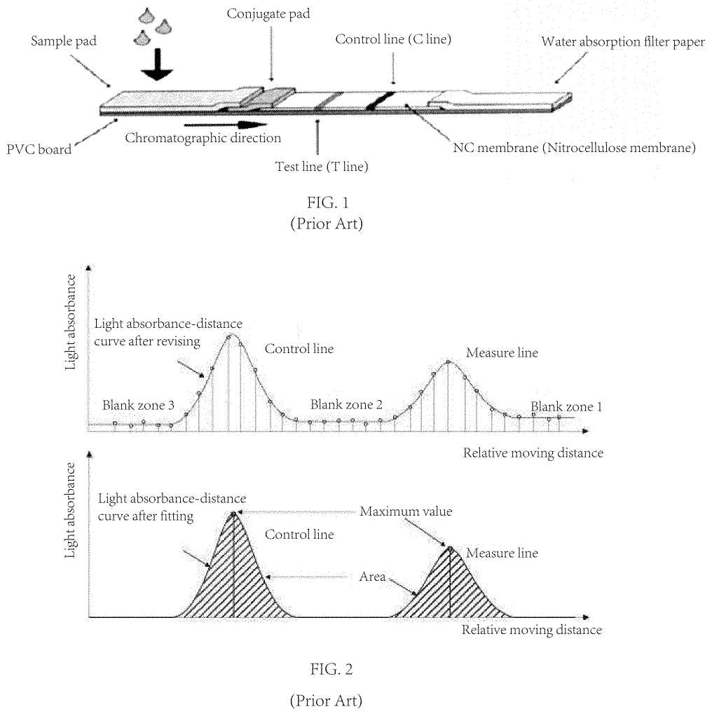

### DETAILED DESCRIPTION OF SPECIFIC EMBODIMENTS

In order to make the object, technical solution and advantage of the present disclosure more comprehensible, the present disclosure will be further described in detail below with reference to the accompanying drawings and embodiments. It is understood that the specific embodiments described herein are merely illustrative of the present disclosure and are not intended to limit the present disclosure.

It should be noted that all directional indications (such as upper, lower, left, right, front, back, etc.) in the embodiments of the present disclosure are limited to the relative position in a specified view, rather than an absolute position.

In addition, the expression “first”, “second”, etc. in the present application are used for the purpose of description only, and are not to be construed as indicating or implying their relative importance or implicitly indicating the number of technical features. Thus, the features defined by “first”, or “second”, etc. may include at least one of the features, either explicitly or implicitly. In the description of the present application, the meaning of “a plurality of” is at least two, such as two, three, etc., unless specifically defined otherwise.

The present disclosure provides a hand-held quantitative detection device, which realizes miniaturization and structural integration of the device under the premise of ensuring the accuracy and capability of quantitative detection. The device is suitable for holding by an adult, and matches the corresponding liquid-sampling device. It is convenient and quick to complete quantitative detection of a specific analyte in a sample to be tested.

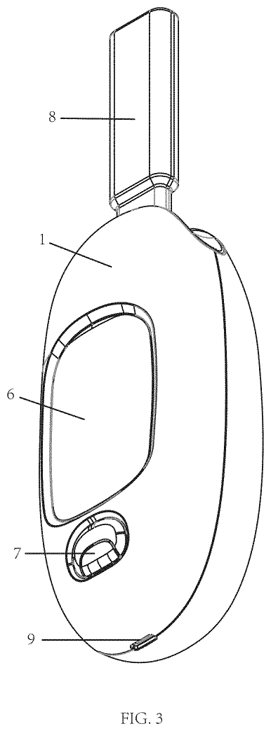

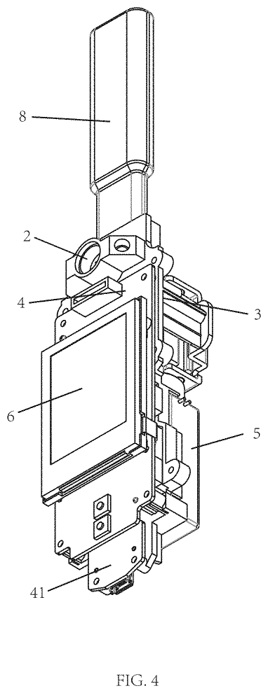

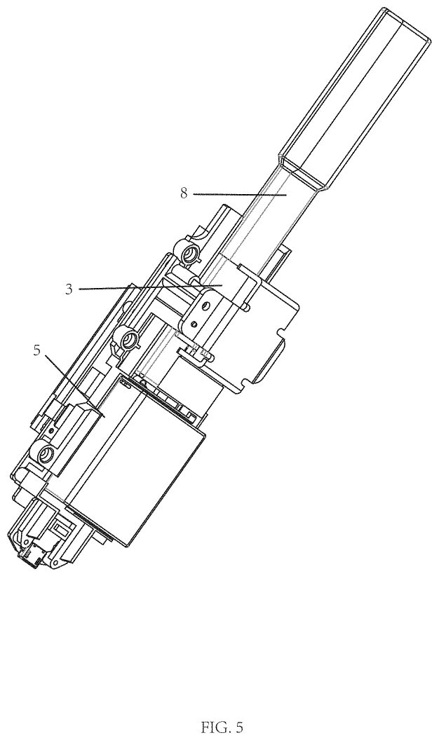

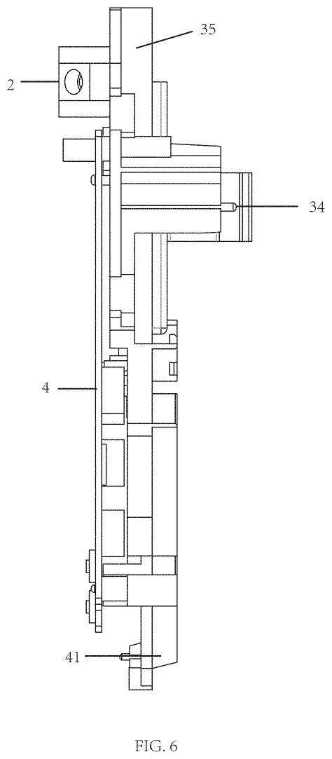

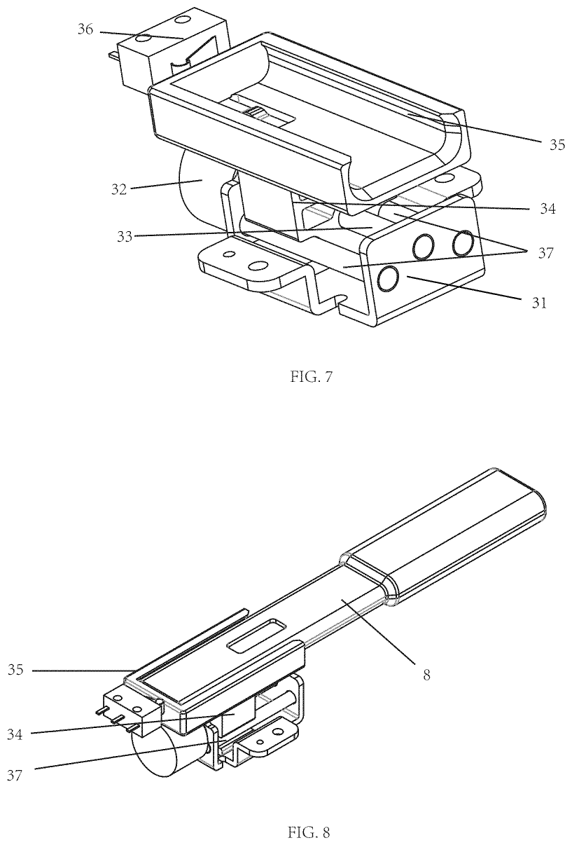

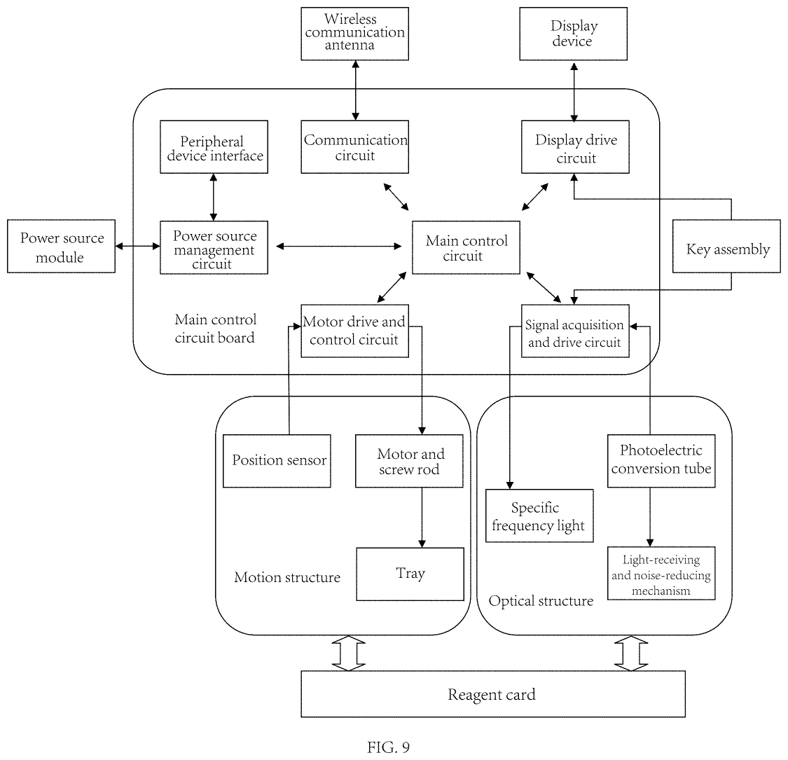

Referring to FIG. 3 to FIG. 8, the detection device may include a housing 1, an optical structure 2 mounted in the housing 1, a motion structure 3, a main control circuit board 4, a power source module 5, and a display device 6 and a key assembly 7 mounted on the housing 1. The housing 1 can be responsible for protecting the internal components and providing a mounting base for the internal components. The display device 6 may be used for displaying the operating state of the device as well as the detection result during human-computer interaction. The key assembly 7 may be used for on/off operation of the device as well as the interactive operation on the display device.

The main control circuit board 4 may be electrically connected to the optical structure 2, the motion structure 3, the power source module 5, the key assembly 7, and the display device 6, respectively. One end of the housing 1 in correspondence with the motion structure 3 may be provided with a first through hole for insertion of a reagent card. The reagent card can be inserted into the detection device through the first through hole to complete the detection. The main control circuit board 4 may be mounted on the housing 1 using a main structural board 41 and may have a front side and a back side. A bottom side of the display device 6 may be soldered to a middle of the front side of the main control circuit board 4. The optical structure 2 may be mounted on one end of the front side of the main control circuit board 4. The motion structure 3 may be mounted on one end of the back side of the main control circuit board 4. The power source module 5 may be mounted in a middle portion of the back side of the main control circuit board 4. The structure is highly integrated so that it can facilitate the realization of miniaturization of the device and high space utilization. It is suitable for an adult to hold and operate. Referring to FIG. 9, the main control circuit board 4 may include a main control circuit, a power source management circuit respectively connected to the main control circuit, a motor drive and control circuit, a signal acquisition and drive circuit, a communication circuit, and a display drive circuit.

The main control circuit can be configured to control the operating state of each of the circuits connected thereto and perform data processing. The detection result can be displayed on the display device 6, or the detection result can be transmitted to an external device through the communication circuit.

The display drive circuit may be electrically connected to the display device in order to drive the display device 6 to display contents. The display device 6 is preferably a liquid crystal display screen. The power source management circuit may be electrically connected to the power source module 5 so as to control charging and discharging of power of the power source module 5. The power source module 5 may be aluminium-ion batteries.

The housing 1 may be provided with a second through hole that corresponds to the key assembly 7. The key assembly 7 may be accommodated in the second through hole.

The key assembly 7 may be electrically connected to the signal acquisition and drive circuit and the display drive circuit, respectively, so as to implement the function of selection and confirmation. The key assembly 7 may include an arc-shaped key and a small key that can coordinate with each other. A recessed portion may be formed on the arc-shaped key and the small key may be engaged in the recessed portion. The structure is compact and pleasing to the eye, and is very suitable for an adult to perform pressing of a key when holding the device by one hand because the finger for pressing the key does not need to be moved over a wide range.

The optical structure 2 can be configured to receive light of specific frequency reflected from the reagent card. It may include a photoelectric conversion tube connected to the signal acquisition and drive circuit, and a light-receiving and noise-reducing structure disposed in a position in correspondence with the photoelectric conversion tube.

The motion structure 3 may be employed to drive the movement of the reagent card, and may include a frame 31 fixed in the housing, a motor 32 mounted on the frame 31, a screw rod 33 connected to an output end of the motor 32, a bearing slider 34 mounted on the screw rod 33, a tray 35 mounted on the bearing slider 34, and a position-limiting sensor 36 mounted on the housing 1. The position-limiting sensor 36 may be electrically connected to the motor drive and control circuit. The position-limiting sensor 36 may be disposed in a position in correspondence with the tray 35 for detecting the position of the tray 35. This can prevent the tray 35 from colliding with the housing 1 and other components. The motor 32 may be electrically connected to the motor drive and control circuit so as to control the operating state of the motor 32.

One side of the tray 35 may be provided with an opening through which a reagent card can be inserted. Through the opening, the reagent card can be inserted into the tray 35 and can be moved together with the tray 35. The size of the tray 35 and the size of the opening can be set according to the reagent card so that lateral shaking of the reagent card can be prevented. In addition, the motion structure 3 may further include two lateral bearing guide rails 37 provided on two sides of the screw rod 33. The bearing slider 34 can slide on the two lateral bearing guide rails 37. The tray 35 may be connected with the screw rod 33 through the bearing slider 34. On one hand, the rotation of the screw rod 33 by the motor can be converted to linear movement of the bearing slide 34, and on the other hand the two lateral bearing guide rails 37 on both sides of the screw rod 33 can share the lateral tangential force that may be encountered. Due to the existence of the two lateral bearing guide rails 37, the motion structure can withstand a relatively strong interfering force in the tangential direction (tangent to the longitudinal direction of the reagent card) so as to ensure stability of the device in shaking or other environment.

The hand-held quantitative detection device may further include a wireless communication antenna disposed within the housing. The wireless communication antenna may be connected to the communication circuit. The detection device can be connected to an external device through the communication circuit and the wireless communication antenna in order to carry out function selection and send the detection result to a corresponding external device. This is very convenient to use.

The other end of the housing 1 may be provided with a third through hole. A peripheral device interface 9 may be mounted in the third through hole and may be connected to the power source management circuit. The peripheral device interface 9 may be used for charging the device and for redundant connection.

The basic process of using and running the detection device is as follows:

1. Reagent card 8 obtains liquid to be tested: after getting a sample to be tested on the reagent card 8 and after reaction of the liquid to be tested is completed, the reagent card 8 is placed in a clean and dry environment (with the observation window facing upward);

2. Start and preparation of the detection device: long-press the “small key” to turn on the device. The display device displays a home page information and the next step is carried out. If the use of a distal operation interface (such as a mobile end, computer-connecting end, etc.) is chosen, then it can be completed at the corresponding device. Otherwise, press the “arc-shaped key” (responsible for the function of switching of items) and the “small key” (responsible for the function of confirmation of items) for a short period of time to carry out test preparation such as selection of the type of substance to be tested and selection of test mode.

3. Detection device performs testing: wait for the observation of colour-changing reaction in the observation window, then insert the reagent card 8 into the prepared detection device through the first through hole of the housing 1. Click the “Start Detection” function option on the distal operation interface or the interactive interface of the detection device. After that, the motor drive and control circuit drives the motor 32 to operate, and then the tray 35 is driven to move through the screw rod 33, so that the observation window for the reagent card slowly moves under the optical structure 2 and operates cooperatively with the signal acquisition and control module. The colour-changing reaction at different positions on the reaction test paper of the reagent card 8 can be recorded.

4. Detection device calculates the test value: based on the condition of the colour-changing reaction on the reaction test paper of the reagent card 8, and through filtering algorithm and concentration calculation algorithm, a built-in program of the device can convert it into a specific analyte concentration content value.

5. Display of result: the currently calculated analyte concentration content value is displayed on an interactive page of the display device or the distal operation interface. The filtering algorithm, the concentration calculation algorithm and the conversion to concentration content value are all existing technology, and the existing technology can be directly used to meet the demand.

It is worth mentioning that the detection device is compact in design. During use, a user can carry the device all the way, or the device can be placed horizontally on a flat table to complete the test. Slight shaking, external vibration or inclined placement of the device does not affect the test results. The test results are accurate.

In summary, the present disclosure provides a hand-held quantitative detection device. The optical structure, the motion structure, the power source module, and the display device are integrated on the main control circuit board, and the degree of integration is high. This facilitates the realization of miniaturization of the device and high space utilization. It is suitable for an adult to hold and operate. It adopts an arc-shaped key and a small key to form a key assembly, which is very suitable for one-hand operation. During use, a user can carry the device all the way, or the device can be placed horizontally on a flat table to complete the test. Slight shaking, external vibration or inclined placement of the device does not affect the test results. The test results are accurate.

The above are only the preferred embodiments of the present disclosure, and are not intended to limit the present disclosure. Any modification, equivalent substitution and improvement made within the spirit and principle of the present disclosure should be included in the scope of protection of the present disclosure.

What is claimed is:

1. A hand-held quantitative detection device, comprising:
a housing;
an optical structure mounted in the housing;
a motion structure;
a main control circuit board;
a power source module;
a display device and a key assembly mounted on the housing;
wherein the main control circuit board is electrically connected to the optical structure, the motion structure, the power source module, the key assembly, and the display device, respectively, one end of the housing in correspondence with the motion structure is provided with a first through hole for insertion of a reagent card, the main control circuit board has a front side and a back side, a bottom side of the display device is soldered to a middle of the front side of the main control circuit board, the optical structure is mounted on one end of the front side of the main control circuit board, the motion structure is mounted on one end of the back side of the main control circuit board, and the power source module is mounted in a middle portion of the back side of the main control circuit board.

2. The hand-held quantitative detection device according to claim 1, wherein the housing is provided with a second through hole in correspondence with the key assembly, and the key assembly is accommodated in the second through hole.

3. The hand-held quantitative detecting device according to claim 1, wherein the key assembly comprises an arc-shaped key and a small key that coordinate with each other, a recessed portion is formed on the arc-shaped key and the small key is engaged in the recessed portion.

4. The hand-held quantitative detection device according to claim 1, wherein the main control circuit board comprises:
a main control circuit;
a power source management circuit respectively connected to the main control circuit;
a motor drive and control circuit;
a signal acquisition and drive circuit;
a communication circuit; and
a display drive circuit;
wherein the key assembly is electrically connected to the signal acquisition and drive circuit and the display drive circuit, respectively, the power source management circuit is electrically connected to the power source module, and the display drive circuit is electrically connected to the display device.

5. The hand-held quantitative detection device according to claim 1, wherein the optical structure comprises:
a photoelectric conversion tube connected to the signal acquisition and drive circuit; and
a light-receiving and noise-reducing structure disposed in a position in correspondence with the photoelectric conversion tube.

6. The hand-held quantitative detection device according to claim 5, wherein the motion structure comprises:
a frame;
a motor mounted on the frame;
a screw rod connected to an output end of the motor;
a bearing slider mounted on the screw rod;
a tray mounted on the bearing slider; and
a position-limiting sensor mounted on the housing;
wherein the position-limiting sensor is electrically connected to the motor drive and control circuit, the position-limiting sensor is disposed in a position in correspondence with the tray, and the motor is electrically connected to the motor drive and control circuit.

7. The hand-held quantitative detection device according to claim 6, wherein the motion structure further comprises two lateral bearing guide rails provided on two sides of the screw rod, and the bearing slider is slidable on the two lateral bearing guide rails.

8. The hand-held quantitative detection device according to claim 5, further comprising a wireless communication antenna disposed within the housing, the wireless communication antenna being connected to the communication circuit.

9. The hand-held quantitative detection device according to claim 4, wherein another end of the housing is provided with a third through hole, and a peripheral device interface is mounted in the third through hole and is connected to the power source management circuit.
